(19) United States
(12) Patent Application Publication
(10) Pub. No.: US 2022/0317985 A1
(43) Pub. Date: Oct. 6, 2022

(54) MACHINE LEARNING MODEL FOR RECOMMENDING SOFTWARE

(71) Applicant: FUJITSU LIMITED, Kawasaki-shi (JP)

(72) Inventors: Max ARSENEAULT, East Palo Alto, CA (US); Wei-Peng CHEN, Fremont, CA (US); Lei LIU, Sunnyvale, CA (US)

(73) Assignee: FUJITSU LIMITED, Kawasaki-shi (JP)

(21) Appl. No.: 17/221,679

(22) Filed: Apr. 2, 2021

(51) Int. Cl. G06F 8/36; G06N 5/00

(52) U.S. Cl. CPC G06F 8/36; G06N 5/003

(57) ABSTRACT

A method may include receiving software artifacts representing previously developed software entities from one or more repository sources. The method may include constructing a knowledge graph of the software artifacts. The method include training, using the knowledge graph, a graph neural network model to recommend one or more of the previously developed software entities for a software development objective. In some aspects, the method may include generating a recommendation including one or more of the previously developed software entities to be used for the software development objective.

### FIELD

The embodiments discussed in the present disclosure are related to a machine learning model for recommending software.

### BACKGROUND

During the process of developing software, software developers may often include previously developed software as part of their project. Using previously developed software may expedite the software development process and decrease associated costs, rather than having software developers develop all the software themselves.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In an example embodiment, a method may include receiving software artifacts representing previously developed software entities from one or more repository sources. The method may include constructing a knowledge graph of the software artifacts. The method may include training, using the knowledge graph, a graph neural network model to recommend one or more of the previously developed software entities for a software development objective.

The objects and advantages of the embodiments will be realized and achieved at least by the elements, features, and combinations particularly pointed out in the claims. Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example of a software development cycle;

FIG. 2 is a diagram representing an example environment related to software recommendation for software development;

FIG. 3 is a diagram of an example of a knowledge graph;

FIG. 4 illustrates a block diagram of an example computing system; and

FIG. 5 is a flowchart of an example method of training a graph neural network model to recommend one or more of the previously developed software entities.

### DETAILED DESCRIPTION

During the process of developing software, software developers may often include previously developed software modules or software entities as part of their software development project. To use a previously developed software entities in a software project (e.g., a software application under development), a software developer may attempt to identify a software entities that meets the requirements for a specific project. However, it may be difficult and time consuming to identify suitable software entities with functionalities that meet the requirements for the specific software development project. In some circumstances, it may not be possible for a software developer to evaluate all available software entities and compare them to one another.

The prevalence of open source software (OSS) has increased the use of previously developed software entities in software development, and the use of OSS has expanded even in the context of enterprise software development. In some circumstances, companies or individual developers contribute to OSS development because collective efforts may often lead to better quality software and also because an ecosystem built on top of OSS typically attracts higher adoption of software. Furthermore, use of OSS often expands the available software entities that developers may choose from for their specific software development projects. However, with the increasing amount of available software entities in OSS, it may be difficult for software developers to choose suitable software entities.

In the present disclosure, reference to a “software module” may refer to code that includes one or more routines configured to enable a computing system to perform one or more tasks. In some embodiments, a software program may include multiple software modules, each configured to cause performance of one or more particular tasks of the software program. Reference to a “software entity” may include a software module, a software program, a software repository, a software package, a software image, a software file, a software chart, any other suitable software entities and/or one or more combinations thereof. Additionally or alternatively, a “software entity” may include groups of the above-mentioned software entities.

Accordingly, the present disclosure includes embodiments to assist in the software development process. In particular, the disclosed embodiments include aspects to recommend software entities for use in software development. Such features may improve the quality of the developed software by identifying which software entities may help satisfy the requirements of the associated software application. Further, such features may decrease the amount of time used to develop software applications by reducing the amount of time used to identify which software entities may be used.

However, there are various challenges associated with recommending software entities. In particular, providing a suitable software entity recommendation may be multifaceted and may depend on various considerations such as a software developer's environment, development stage, intentions, unique preferences, among others. Accordingly, the disclosed embodiments include aspects related to training a graph neural network (GNN) model to recommend certain software entities for certain tasks of a software project, which in turn may provide the flexibility to address such considerations. Such recommendations may be tailored to a specific software developer and/or a specific software development project.

The disclosed embodiments include a GNN model, which is a machine learning model, which may be trained to recommend software entities for using in software development. The GNN model may implement embedding schema to a knowledge graph with multiple layers of granularity. In some embodiments, code of a software project and query may be used as inputs and an output may be generated including a software recommendation related to the stage in the software development cycle of the software project. The query may include a request for a software entity recommendation and/or criteria for the software entity recommendation.

The software recommendation may include one or more software entities each configured to perform a particular type of operation. The computation may be performed via a multi-level knowledge graph that models the hierarchical relationship of various software entities. The disclosed embodiments may include an algorithm which generates multimodal graph embeddings by aggregating neighbor embeddings. The recommendations may be generated from a hybrid approach involving collaborative filtering and association rule mining. Additionally or alternatively, the disclosed configurations may allow for dynamic recommendations in response to software developer decisions.

Embodiments of the present disclosure are explained with reference to the accompanying drawings.

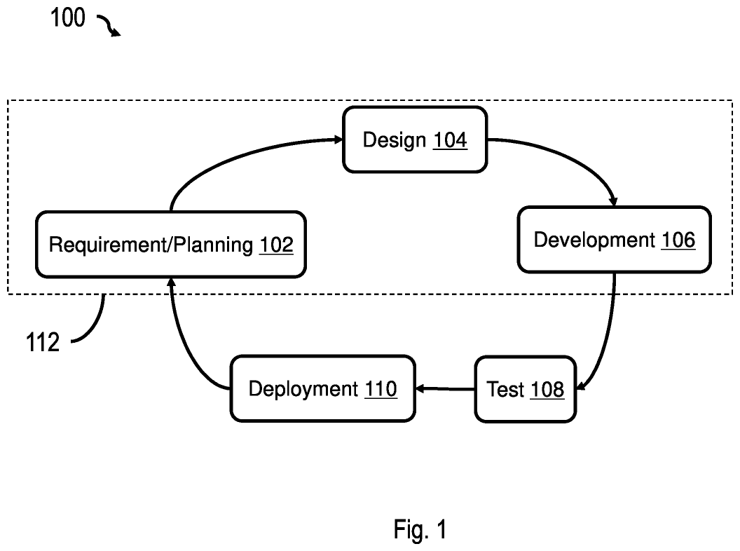

FIG. 1 is a diagram representing an example of a software development cycle 100 of a software application. The software development cycle 100 may include a requirement and planning phase 102, a design phase 104, a development phase 106, a testing phase 108, and a deployment phase 110. As indicated by the interconnecting arrows, the phases 102-110 may be repeated throughout the software development cycle 100. As will be described in further detail below, the disclosed embodiments may assist in the planning phase 102, the design phase 104, and the development phase 106 by recommending existing software entities to be used in the software development cycle 100, as denoted by 112.

In some circumstances, the software development cycle 100 may include containerization. Containerization involves packaging a software application along with corresponding libraries, frameworks, and configuration files together so that the software application may be run in various computing environments efficiently. In this way, a container may be a standardized unit of software development and deployment, and also may be considered an independent software entity. Containerization may reduce wasted computing resources due to large overhead. Furthermore, containerization may permit software developers to easily reuse existing software entities. One example of a container is a Docker container.

The software development cycle 100 may include developers selecting software entities to be used for a software development objective, corresponding to the requirement and planning phase 102 and/or the design phase 104. The software development cycle 100 may include developers developing new software entities or adapting the existing software entities to be used for a software development objective, corresponding to the development phase 106. The disclosed embodiments may assist in selecting suitable software entities, corresponding to the requirement and planning phase 102, the design phase 104, and/or the development phase 106.

In particular, there may be different circumstances in the software development cycle 100 where recommendations regarding software entities may be helpful. The disclosed embodiments may provide the flexibility to provide recommendations throughout the software development cycle 100. In addition, the disclosed embodiments may be dynamically and/or iteratively fine-tuned, for example, using historical user data and additional datasets.

In one example, a user may request a specific software entity and/or may provide a user input (e.g., query description) of objectives without context corresponding to a partially-completed project (e.g., at the beginning of a project). In another example, a user may request a specific software entity and/or provide a user input (e.g., query description) of objectives with additional context corresponding to a partially-completed project. In yet another example, a user may request an alternative but equivalent recommendation that meets certain objectives or criteria (e.g., version, operating system, programming language, stage in the software development cycle, etc.). In yet another example, the user input may include packages utilized in the software development cycle 100. The disclosed embodiments may provide recommendations for the above-described examples.

For recommendations during the design phase 104, a user may only have a vague idea of the software requirements and no software entities may have been adopted for a specific project. In such circumstances, a user may provide a user input including, for example, natural language, keywords, categories of application, etc. to describe the objectives and/or criteria.

For recommendations during the development phase 106, a user may have additional requirements because the software development project is further along in the software development cycle 100. For example, some software entities may already be selected for the software development project. Additionally or alternatively, the user may be looking for software entities with specific features. In such circumstances, a user may provide a user input including, for example, software components that are already implemented or selected for the software development project (e.g., packages utilized in the software development cycle 100).

In some embodiments, a system may provide a recommendation of software entities to be used for the software development project based on the user input. As indicated above, the user input may vary depending on the phase of the software development cycle 100 such that the recommendations may vary depending on the phase of the software development cycle 100. The generated recommendations will be discussed in further detail below.

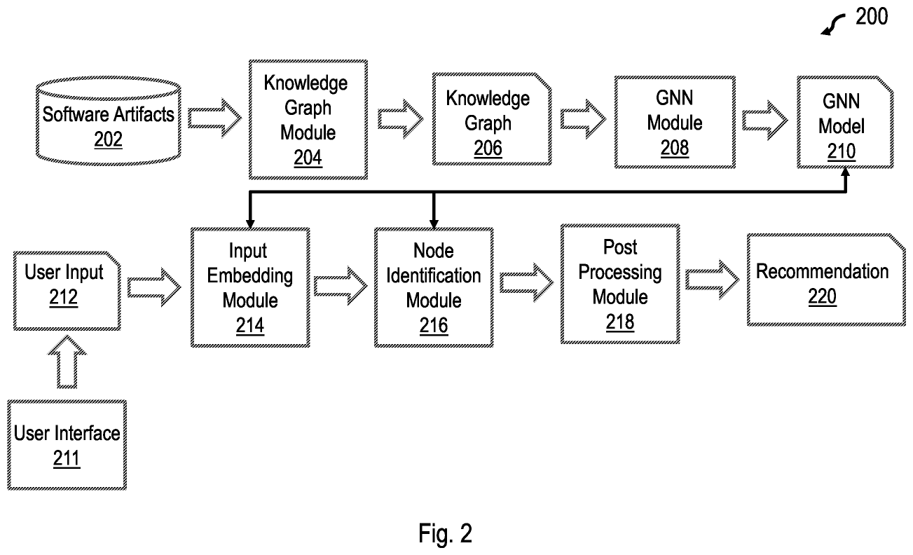

FIG. 2 is a diagram representing an example environment 200 related to software recommendation for software development, arranged in accordance with at least one embodiment described in the present disclosure. The environment 200 may be implemented, for example, to assist in the software development cycle 100. In particular, the environment 200 may assist in the planning phase 102, the design phase 104, and the development phase 106 by recommending existing software entities to be used in the software development cycle 100.

The environment 200 may include a knowledge graph module 204, which may receive software artifacts 202 representing previously developed software entities from one or more repository sources. The knowledge graph module 204 may construct a knowledge graph 206 based on the software artifacts 202. In particular, the knowledge graph module 204 may construct the knowledge graph 206 to represent the software artifacts 202 received from the one or more repository sources. For example, the knowledge graph 206 may represent the software artifacts 202 as nodes and the relationships between the software artifacts 202 as edges.

The environment 200 may include a GNN module 208 that trains a GNN model 210 using the knowledge graph 206. The GNN model 210 may be a machine-learning model. The GNN model 210 may be trained to recommend one or more of the previously developed software entities represented by the software artifacts 202 for a software development objective. In some embodiments, the GNN model 210 may be hierarchical including different types of nodes that represent different types of existing software entities.

The environment 200 may include an input embedding module 214 that receives a user input 212 (e.g., from a user that is a software developer). The user may input the user input 212 via a user interface 211 configured to receive the inputs from the user. In some embodiments, the user input 212 may include a natural language query or natural language text. The user input 212 may include packages utilized in the software development objective. Additionally or alternatively, other suitable inputs may be implemented. The input embedding module 214 may convert the user input 212 to embedding. In some aspects, the embedding of the user input 212 may be combined with other modalities (e.g., topic embeddings, embedding of packages and/or embedding of other software modules) to generate multimodal embedding. In particular, the input embedding module 214 may generate multimodal embedding from natural language query and/or other information provided in the user input 212, which may represent entities and relationships in the knowledge graph 206 in a continuous vector space. In some configurations, the user interface 211 may be configured to display the knowledge graph 206, which may include, for example, nodes representing the software artifacts and edges representing relationships between the software artifacts.

Accordingly, the input embedding module 214 may generate embedding from the user input 212, as will be described in further detail below. In some configurations, converting the user input 212 to the embedding may include generating a pseudo-node and/or adding the pseudo-node to the knowledge graph 206. The pseudo-node may include any suitable information such as description of requirements, keywords, filtering options, adopted packages, etc. The pseudo-node may be added and/or wired into the knowledge graph 206 at various levels in its hierarchy. Accordingly, the pseudo-node may include edges representing relationships between the pseudo-node and other nodes in the knowledge graph 206.

A node identification module 216 may receive the embedding and/or the pseudo-node from the input embedding module 214 and may search for similar nodes or nearby nodes in the knowledge graph 206 using the GNN model 210. Accordingly, the node identification module 216 may identify nodes in the knowledge graph 206 that are similar to the embedding or the pseudo-node corresponding to the user input 212 query. The GNN model 210 may use parameters to generate new graph embeddings for the pseudo-node in the knowledge graph 206. Such aspects will be described in further detail below.

A post-processing module 218 may receive the similar nodes from the node identification module 216 and may generate a recommendation 220. The post-processing module 218 may generate the recommendation 220 based on the similar nodes identified by the node identification module 216. The recommendation 220 may include one or more of the previously developed software entities from the repository sources that are represented by the software artifacts 202 to be used for a software development objective (e.g., the software development cycle 100). In some configurations, filtering may be applied to the generated recommendation 220 and/or the recommendation 220 may be presented to the user (e.g., via the user interface 211).

With continued reference to FIG. 2, the various aspects of the environment 200 will be described in further detail. The software artifacts 202 may represent a variety of existing software entities. In some configurations, the existing software entities may be OSS entities, although the described configurations may be applicable to any suitable software entities.

OSS entities that may represented by the software artifacts 202 will be described as an example to illustrate potential existing software entities. The software artifacts 202 may include one or more OSS packages or OSS libraries, which may support specific functionalities to be reused by other software. The OSS packages may be stand-alone, open-source software entities. In some aspects, the OSS packages may have dependencies on one or more other OSS packages. The software artifacts 202 may include one or more Dockerfiles, which may include a text document that includes the commands a user could call on the command line to assemble an image. Dockerfiles may be used to import OSS packages and may include a Docker base image. The software artifacts 202 may include one or more Docker images or Docker base images. The Docker images may be an instance of a Docker container. The Docker images may be built from a Dockerfile which, as explained above, may import OSS Packages and may include a Docker Base Image.

The software artifacts 202 may include one or more repositories, which may include a collection of software entities of arbitrary scale, usually corresponding to a complete project or application. Repositories may include OSS Packages, Docker images, Docker-compose files and/or other suitable software entities. Some examples of repositories include GitHub and DockerHub, although any suitable repositories may be implemented. The software artifacts 202 may include one or more Docker-compose files, which may include a configuration file for an application's services. Docker-compose files may be implemented to define and run multi-container Docker applications. Docker-compose files may include multiple containers in the form of Docker images. The software artifacts 202 may include one or more Helm charts. A Helm chart may include a collection of files that describe a related set of Kubernetes resources and may be organized as a collection of files inside of a directory. Helm charts may have dependencies on other Helm charts and may include Docker images.

The existing software entities may have various relationships and interdependencies among one another. Such relationships may be described by a knowledge graph, such as the knowledge graph 206. Accordingly, the software artifacts 202 may be described by the knowledge graph 206, which may represent the various relationships between the existing software entities.

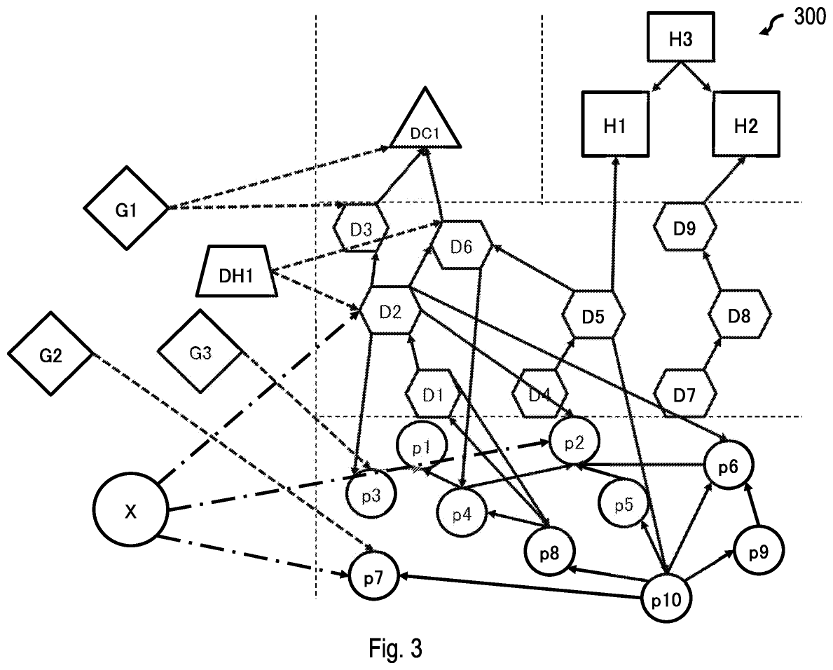

FIG. 3 is a diagram of an example of a knowledge graph 300. The knowledge graph 300 may correspond to the knowledge graph 206 of the environment 200, although other suitable knowledge graphs may be implemented according to the concepts described herein. In the knowledge graph 300 illustrated, various software entities are represented by nodes. Edges, which are represented by lines interconnecting the nodes, represent the various relationships between the nodes. The nodes of the knowledge graph 300 may correspond to the software artifacts 202 of the environment 200 described above.

The illustrated knowledge graph 300 includes various repositories, such as Github repositories G1-G3 and DockerHub repository DH1. The knowledge graph 300 also includes OSS packages p1-p10, Docker images D1-D9, Docker-compose file DC1, and Helm charts H1-H3. As illustrated by the dashed lines, the knowledge graph 300 may group the various nodes based on different types. Accordingly, the knowledge graph 300 may include different layers for the OSS packages p1-p10, Docker images D1-D9, Docker-compose file DC1, and Helm charts H1-H3. A node for one of the repositories G1-G3 and DH1 corresponds to the other software entities. In the illustrated configuration, the repositories G1-G3 and DH1 are modeled by their own nodes. In other configurations, the relevant entities of the repositories G1-G3 and DH1 may be distributed as separate nodes in the knowledge graph 300.

The relationships between the nodes of the knowledge graph 300 are represented by edges. The knowledge graph 300 may include multiple different types of edge relations. For instance, a Docker image may be connected to an OSS package if its Dockerfile installs that package. An OSS package may be connected to another OSS package if it depends on that other package (i.e. imported in the code). Other relationships between the nodes may also be represented in the knowledge graph 300.

In the disclosed configurations, the nodes of the knowledge graph 300 may have multiple functions. For example, a node may function independently with its own attributes and/or a node may function as a collection of other nodes. The first individual function may be the semantic meaning of the node and the second grouped function may be the information for learning code combinations. The nodes that symbolize software entities that do not include any other constituent nodes may be referred to as atomic nodes. The nodes that symbolize software entities that include other constituent nodes may be referred to as composite nodes. In such configurations, the composite node may include properties of its own, while also including properties associated with constituent nodes. A node may be functionally atomic if such dependencies are functionally irrelevant (e.g. the user can import the package into their project without ever considering its dependencies).

As mentioned above, a knowledge graph (such as the knowledge graph 300 and/or the knowledge graph 206) may be used to train a GNN module, such as the GNN model 210. In particular, the GNN module 208 may train the GNN model 210 using the knowledge graph 206. Accordingly, with reference to FIGS. 2 and 3, training the GNN model 210 will be described in greater detail.

In some configurations, training the GNN model 210 may include aggregating information using a machine learning graph convolutional algorithm (e.g., by the GNN module 208). In particular, the machine learning graph convolutional algorithm may be implemented to aggregate information, such as embedding information, from neighbors on the knowledge graph 300 so that pairs of entities that are considered close are embedded nearby in the embedding space. One example of a suitable algorithm may include the GraphSAGE algorithm. The GraphSAGE algorithm may leverage constituent information (in both directions) to augment any insufficient or missing description embedding. Using the GraphSAGE algorithm to aggregate embedding information from neighbors may allow for augmentation of overall embedding quality with respect to recall, as well as embedding construction for nodes with no attributes (i.e. null embeddings).

In some configurations, training data may be used to train the GNN model 210. The training data in turn may be used to generate node embeddings. In one example, training data may include pairs of Docker nodes. The Docker nodes may be labeled with ±1 depending on whether the nodes share 1 or more packages. Additionally or alternatively, training data maybe used may be used to evaluate the GNN model 210. Training data may include Docker nodes with a partially masked list of packages. The training data may be wired into the GNN model 210 and collaborative filtering via a k-nearest neighbors algorithm may be applied to attempt to predict these masked packages. Once the prediction is generated, it may be evaluated to determine the effectiveness of the GNN model 210.

In another example, the training data may include pairs of Docker-compose nodes. The Docker-compose nodes may be labeled with ±1 depending on whether the nodes share 1 or more Docker images. The training data may include Docker-Compose nodes with masked lists of Docker images. As described above, the training data is used to train the GNN model 210 and the training data may be wired into the GNN model 210 and collaborative filtering via a k-nearest neighbors algorithm may be applied to attempt to predict these masked packages.

In yet another example, the training data may include pairs of package nodes, labeled with ±1 depending on whether the nodes are co-imported in a Dockerfile. The training data may include pairs (q, i). Given the embedding for package q, a package may be recalled i by considering its nearest neighbors. Once the prediction is generated, it may be evaluated to determine the effectiveness of the GNN model 210.

In some configurations, the algorithm may be configured to consider or not consider certain edges of the knowledge graph 300, weigh some edges differently than others, perform different random walks through the edges depending on the node, etc. Additionally or alternatively, the graph structure of the knowledge graph 300 may determine various outcomes based on the graph embedding generated, even if the edges of the knowledge graph 300 are treated equivalently.

The algorithm may be configured to determine what entities or nodes of the knowledge graph 300 are considered close to one another. For example, pairs of repositories, pairs of packages co-imported in Dockerfiles, packages that depend on other packages, Docker images that are co-imported within Docker-Compose files, etc. may be considered to be close to one another. Additionally or alternatively, closeness may be defined based on pairs that are similar and/or close in the knowledge graph 300. In some configurations, the algorithm may be tuned or refined in response to newly obtained data and, given user input, embeddings may be generated continuously or iteratively.

In some configurations, the GNN model 210 may be trained using pairs of co-imported atomic nodes (e.g., pairs of packages imported in Dockerfiles) as positive examples. In such configurations, the pseudo-node may act as another package or Docker image in the knowledge graph 300 (e.g., as an atomic node).

In other configurations, the GNN model 210 may be trained using pairs of overlapping composite nodes (e.g., pairs of Dockerfiles that overlap in their sets of imported packages) as positive examples. In such configurations, the pseudo-node may act as if it were a repository with a collection of packages and images (e.g., as a composite node)

The algorithm may be configured to provide recommendations across different layers of the knowledge graph 300. In particular, the algorithm may be configured to recommend software entities at any of the layers of the knowledge graph 300 and use the other layers' interconnections as a context for embeddings at that layer.

In some configurations, the recommendations provided may only include atomic or functionally atomic nodes, and thus corresponding software entity recommendations. Accordingly, the recommendations may include, for example, Docker images and/or packages, because those entities are atomic or functionally atomic. In contrast, composite nodes may not be provided in recommendations. Rather, composite nodes are relevant for their role in collaborative filtering and the co-occurrence information they provide. In some aspects, packages may also have constituents if package dependencies are considered in in determining functionality and associations.

In some configurations, after the algorithm and/or the GNN model 210 is trained, a pseudo-node may be created or wired into the knowledge graph 206 and/or the knowledge graph 300. For example, in FIG. 3, a pseudo-node X may be created, added and/or wired into the knowledge graph 300. The pseudo-node X may include any suitable information such as description of requirements, keywords, filtering options, adopted packages, etc.

In some configurations, the pseudo-node X may be generated based on a user input, such as the user input 212 of FIG. 2. In some circumstances, the user input 212 may include: a natural language description of requirements or criteria for the software development project; keywords associated with the software development project; filtering options or criteria; application category selections; selection of software entities or groups of software entities; confirmation of selections; packages utilized in the software development project and/or other suitable user inputs.

In some aspects, adding the pseudo-node X to the knowledge graph 300 may include generating an embedding for the pseudo-node X. For example, the input embedding module 214 may receive the user input 212 may convert the user input 212 to embedding. In one example, the embedding may include Bidirectional Encoder Representations from Transformers (BERT) embedding. Further, a new node may be added to the knowledge graph 300 to represent the pseudo-node X with the embedding for the pseudo-node X (e.g., including the embedding as an attribute).

The pseudo-node X may be associated with artifacts, such as packages, Docker images or other suitable artifacts. For each artifact associated with the pseudo-node X, an edge connection may be added from the pseudo-node X to the artifact's respective node in the knowledge graph 300. For example, as illustrated in FIG. 3, the pseudo-node X includes edges to packages p2 and p7, as well as Docker image D2.

In some configurations, a machine learning graph convolutional algorithm may be used to generate the embedding for the pseudo-node X. One example of a suitable algorithm may include the GraphSAGE algorithm. The algorithm may be run using the pre-trained parameters, as described above. The pseudo-node X may be used as an input for the algorithm and the output of the algorithm may be the embedding of the pseudo-node X (e.g., GraphSAGE embedding).

In some configurations, the GraphSAGE algorithm may be implemented to generate multimodal embeddings. Depending on the information extractable from the nodes in the knowledge graph 300, a variety of multimodal embeddings may be generated. The types of embeddings may include a one-hot representation of children nodes, topic model embeddings, code embeddings, and natural language embeddings, as well as auxiliary information such as the node type and degree.

As mentioned above, the pseudo-node X may be created or wired into the knowledge graph 206. In some aspects, the multimodal embeddings may be concatenated. The edges of the wired-in pseudo-node X and the concatenated embeddings may be input to the GraphSAGE algorithm. The output of the GraphSAGE algorithm may be the graph embedding of the newly added pseudo-node X.

For example, information from GitHub repositories may include keywords, topics, descriptions, and readable text. Results may be generated with a pre-trained BERT embedding (which may be trained on Stack Overflow posts, for example) generated from a description field, a latent semantic analysis topic vector generated from a description field and/or keywords, the node type (e.g. package, Docker, Docker compose, etc.), and the logarithm of the node degree. A concatenation of these embeddings may be used in a preliminary recommendation system, which may be implemented to identify nearest neighbor embeddings using cosine similarity. In some configurations, the GraphSAGE algorithm may be implemented using random walks to determine neighbors (e.g., neighboring nodes).

As mentioned above, the input embedding module 214 may convert the user input 212 to embedding. With continued reference to FIGS. 2 and 3, converting the user input 212 to embedding will be described in further detail. The input embedding module 214 may receive the user input 212, which may include a natural language description (e.g., a description of desired criteria for the software development project) and/or packages utilized in the software development objective. The input embedding module 214 may then generate embeddings from the natural language description. The input embedding module 214 may be configured to identify whether the natural language description includes topic keywords. In response to the natural language description including topic keywords, the input embedding module 214 may generate topic embeddings based on the topic keywords and may add wire-in links (e.g., edges) from the pseudo-node X to the topic composite node, for example, as illustrated in FIG. 3.

After the topic embeddings are generated, the input embedding module 214 may determine whether the topic embeddings include an adopted software module or group of software modules. In response to the topic embeddings including an adopted software module or group of software modules, the input embedding module 214 may add wire-in links (e.g., edges) from pseudo-node X to the topic composite node, for example, as illustrated in FIG. 3.

Once the wire-in links (e.g., edges) are added to the knowledge graph 300 from the pseudo-node X to the topic composite node, the input embedding module 214 may proceed to concatenate the embeddings together with wire-in links (e.g., edges) to generate graph embedding for newly created pseudo-node X, for example, as illustrated in FIG. 3.

Thus, the input embedding module 214 may concatenate the multimodal embeddings with edges in the knowledge graph 300 to generate graph embedding for the pseudo-node X. In particular, the input embedding module 214 may concatenate the multimodal embeddings and the edges of the wired-in pseudo-node X and the concatenated embeddings may be input to an algorithm (e.g., the GraphSAGE algorithm). The output of algorithm may be the graph embedding of the pseudo-node X.

In some circumstances, a k-nearest neighbors algorithm may be applied to non-GraphSAGE embedding of the description of the other nodes. Examples of a non-GraphSAGE embedding include a concatenation of BERT embeddings, topic modeling embeddings, and/or one-hot embeddings of outgoing edges. GraphSAGE may not be implemented in such circumstances because there may be no provided packages to form edges with. In such circumstances, the GraphSAGE step may not be implemented because there is no context provided by the user input 212 to integrate into the meaning of the knowledge graph 300. For example, in instances in which the user input 212 only refers to a target software entity. As explained above, GraphSAGE may be used to integrate context into the meaning of an embedding. Thus, in this circumstance the embeddings' meaning may be those of the raw atomic nodes and not those formed by GraphSAGE's aggregation steps described above.

In circumstances where the user input 212 requests a software entity, the closest embedding to an embedded query may be returned. The natural language description provided in the user input 212 may be considered an atomic node. The k-nearest neighbors to a non-GraphSAGE embedding of the user input 212 may be returned, searching across the non-GraphSAGE embeddings of functionally atomic nodes (e.g., Docker base images or packages with specific functions).

In circumstances where the user input 212 describes the software development objectives at a high-level, the natural language description provided in the user input 212 may be considered a composite node. The k-nearest neighbors to a non-GraphSAGE embedding of the user input 212 may be returned, searching across the non-GraphSAGE embeddings of composite nodes (e.g., GitHub repositories, Dockerfiles, Docker-Compose files, Helm Charts, etc.). Collaborative filtering may be performed of the closest composite nodes to determine most frequently used software entities. Collaborative filtering may be used to return the most frequently used functionally atomic nodes (e.g., Docker base images or packages, that may exist in groups of software entities).

The GraphSAGE embedding of the description may be compared to those of the other nodes. In one example, a composite node may be reconstructed to resemble a finished user project of the pseudo-node X. The software entities provided in the user input 212 may be treated as fragments of a completed project, and the completed project may be reconstructed in the knowledge graph 300 based on the provided software entities. In another example, GraphSAGE embeddings may be evaluated via a look-up table of each of the user's dependent packages. The dependent packages may include aggregated information from, for example, dependent packages or repositories in which they appear.

As mentioned above, the post-processing module 218 may receive the similar nodes from the node identification module 216 and may generate the recommendation 220. In one example, the user input 212 may include a request to identify a software entity that is compatible with a specific operating system. In such circumstances, the recommendation 220 may include an abstracted super-node that is unrelated to any specific operating-system, programming-language, software development cycle, and version information. All alternative options for recommendations for the software entity may be condensed in this node for the user to view and/or filter. Pointers in the knowledge graph 206 may be used to illustrate the recommendations for the software entity. These pointers may be included throughout the knowledge graph 206, forming highways between equivalent versions of software entities that are in another version, operating system, programming language, software development stage, etc. In some configurations, the recommendations may be collapsible to a single super-node, to allow recall of alternate versions of the software entity. For example, the recommendation 220 may include a super-node corresponding to “NumPy,” but upon considering the user-provided filtering information (e.g., provided in natural language, specifying a version or other compatibility requirements). Accordingly, the recommendation 220 may include the best matched version of NumPy within the super-node.

In the disclosed embodiments, the user (via the user input 212), may select software entities or groups of software entities (e.g., software packages). Additionally or alternatively, the user may select amongst the suggested packages, choosing to add or remove software entities. As the user adds/removes groups of software entities, the association of the pseudo-node X in the knowledge graph 300 may change (e.g., the wiring of the pseudo-node X changes). Different wiring will result in a different set of neighbors visited by the random walks of the algorithm (e.g., the GraphSAGE algorithm). This in turn results in more contextualized embedding and, in turn, improved recommendations 220. Thus, when the user adds a user input 212, the wiring of the knowledge graph 300 changes resulting in different GraphSAGE embedding and thus different recommendations. In some configurations, the user may iteratively provide user inputs based on recommendations, in turn generating different recommendations. Accordingly, the user input 212 and recommendation 220 process may be iterative or cyclical. Further, the process may accordingly be adaptive such that the recommendations may be adapted as the software development process progresses.

In some configurations, mined association rules may be used to produce a list of associated elements to be used for the GNN model 210. The mined association rules may include rules in the form of “P→Q.” The rules may be obtained via association rule mining. In one example, the Apriori algorithm may be used to identify the rules. In instances in which the user provides a user input 212 with one or more current application elements (e.g., NumPy, mongo, etc.), the current application elements may be evaluated to determine whether they match the pre-condition(s) of any of the mined association rules. Based on whether the current application elements match the mined association rules, a post-condition may be recommended. In some configurations, confidence values may be determined for the recommendations from metrics such as the lift or support.

As mentioned above, collaborative filtering may be performed of the closest composite nodes to determine most frequently used software entities and collaborative filtering may be used to return the most frequently used functionally atomic nodes. Collaborative filtering may include user-item collaborative-filtering where a user-to-user similarity metric may be the cosine similarity. The composite nodes (e.g., repositories, Docker-compose files, Dockerfiles, Helm Charts, etc.) correspond to users and the functionally atomic nodes (e.g., Docker images, packages) correspond to items. From the k-nearest neighbor composite nodes (users), any suitable collaborative filtering algorithm may be implemented to recommend constituent atomic nodes (items). In some configurations, a merging step may be performed by obtaining a weighted average of the scores obtained from the recommendation procedures described above. This weight may be treated as another hyperparameter during testing.

In some configurations, the recommendation 220 may include identification of missing elements of the software development project. For example, the recommendation 220 may include software modules that may be missing from the user's software development project. In such configurations, the above-described recommendation procedures may be implemented to generate the recommendation 220 including software modules that have been determined to be missing from the software development project.

In one example, a partially-completed GitHub repository may be evaluated to determine where the software project is in the software development cycle 100. The software entities recommended to the user in the recommendation 220 may change depending on the stage of the software development cycle 100. In response to the software project being almost ready for deployment, the recommendation 220 may not include high-granularity software entities such as a package (e.g., PyTorch). Instead, the recommendation 220 may include multi-container architectures or other containers.

Estimation of the stage in the software development cycle 100 may be performed in several different manners. In one example, rule-of-thumb inferences may be implemented to estimate the user's stage in the software development cycle 100. In such configurations, statistics on average numbers of Docker images used for software development projects may be collected. The stage in the software development cycle 100 may then be inferred based on the absence of certain entities. For example, if the user has no Docker images, they are likely in the development stage. Additionally or alternatively, this determination may be dynamically learn from user interactions.

In another example, machine-learned multi-class classifications may be implemented to estimate the stage in the software development cycle 100. In such configurations, a collection of partially completed project repositories may be constructed or obtained and labeled by the stage they are in. Next, a multi-class classifier algorithm (e.g., multi-class support vector machine) may be trained to estimate the stage of the software development cycle 100 during real-time use.

In yet another example, user-provided software development stages classifications may be implemented to estimate the stage in the software development cycle 100. In such configurations, the user may input the stage of the software development cycle 100 that they are engaged in. Situational rules may be implemented depending on the user input, and in some configurations the user input may include the situational rules.

In some configurations, the recommendation 220 made by the post-processing module 218 may be augmented with Association Rule Mining (ARM), which may be performed via the Apriori algorithm, for example. In some configurations, common co-occurrences of atomic nodes within a composite node may be mined for recommendation scores. These recommendation scores may be combined with the others via a tunable linear weighting or other suitable weighting criteria. Due to the hierarchical nature of the nodes in the knowledge graph 300, association rule mining may be performed at multiple degrees of resolution. In particular, association rule mining may be performed on functionally atomic nodes (e.g., Docker images, OSS packages, etc.) as well as composite nodes (e.g., Dockerfiles, repositories, Docker-compose files, etc.)

In some circumstances, the user may not provide packages that function as a starting point for providing a recommendation. Without provided packages, a pseudo-node cannot be wired into the knowledge graph 300 and thus a GraphSAGE embedding cannot be generated. In such configurations, a pre-GraphSAGE embedding maybe implemented instead. A pre-GraphSAGE embedding may be, for example, a BERT embedding of the user input 212. In some configurations, keywords from the user input 212 may be used. For each possible keyword, a topic node may be generated that connects all nodes with that keyword as an attribute. In instances in which the user input 212 includes a keywords, the pseudo-node may be wired into the knowledge graph 300 and GraphSAGE embedding may be generated based on the keywords.

As mentioned above, an algorithm (such as the GraphSAGE algorithm) may be configured to determine what entities or nodes of the knowledge graph 300 are considered close to one another. In some configurations, training the GNN model 210 may include providing examples of similar embeddings or nodes and/or examples of dissimilar and embeddings or nodes. However, in instances in which the knowledge graph 300 includes relationships between composite nodes and atomic nodes training the GNN model 210 may be more complicated. In such configurations, training the GNN model 210 may include classifying composite nodes with overlapping sets of constituents as similar. Then the GraphSAGE algorithm pseudo-node reconstruction may be a composite node. In such configurations, k-nearest neighbors may be returned as similar molecular nodes. Further, this configuration may be implemented over several degrees of scale. Next collaborative filtering may be applied to determine their most frequently used software entities. The GNN model 210 may be trained such that functionally atomic nodes that tend to be co-constituents together are considered similar. Then GraphSAGE algorithm may reconstruct a pseudo-node as an atomic node, and the k-nearest neighbors algorithm may return similar atomic nodes.

As described in further detail above, the disclosed embodiments include configurations to recommend one or multiple software entities (e.g., to users) based on a machine-learning. In some embodiments, the user interface 211 may be interactive and progressive to receive the user input 212 during different stages of the software development cycle 100. The user input 212 from users may be used to dynamically generate a new node in the knowledge graph 300 to query the trained GNN model 210 for multiple types of recommendations (e.g., the recommendation 220).

In some configurations, the user input 212 may include a high-level abstract description (e.g., natural language description) that may be converted to embedding of the pseudo node X. Then the K-nearest neighbors of the pseudo node X is identified in the knowledge graph 300. Next, collaborative filtering may be applied to generate the recommendation 220 regarding one or more software entities to be used in a software development project.

In circumstances where users have adopted one or multiple groups of software entities, the pseudo node X may be created with wire-in links to the adopted of software entities (or groups). The embedding of the pseudo node X may be calculated using the GNN model 210, the K-nearest neighbors of the pseudo node X may be identified in the knowledge graph 300. Associated rule mining and collaborative filtering may be applied to generate the recommendation 220 regarding one or more software entities to be used in a software development project. In such configurations, the user may provide one or multiple types of the user input 212 to form multi-modal inputs, which are then used to generate the recommendation 220. The GNN model 210 may include a hierarchical graph structure (e.g., the knowledge graph 300) to create its graph neural networks. Depending on the scope of user's requirements, the recommendation 220 may include any suitable levels of software elements, such as repositories, package libraries, Dockerfiles, Docker-compose files, Helm charts, etc. In some configurations, the GraphSAGE algorithm may be used to train the GNN model 210 on heterogeneous types of artifacts.

Modifications, additions, or omissions may be made to the configurations of FIGS. 2 and 3 without departing from the scope of the present disclosure. For example, the environment 200 may include more or fewer elements than those illustrated and described in the present disclosure.

In addition, the different modules described with respect to the environment 200 may include code and routines configured to enable a computing device to perform one or more operations described with respect to the corresponding module. Additionally or alternatively, one or more of the modules may be implemented using hardware including a processor, a microprocessor (e.g., to perform or control performance of one or more operations), a field-programmable gate array (FPGA), or an application-specific integrated circuit (ASIC). In some other instances, one or more of the modules may be implemented using a combination of hardware and software. In the present disclosure, operations described as being performed by a particular module include operations that the particular module may direct a corresponding system to perform.

Further, in some embodiments, one or more routines, one or more instructions, or at least a portion of code of the two or more of the described modules may be combined such that they may be considered the same element or may have common sections that may be considered part of two or more of the modules. The delineation of the modules in the description and FIG. 2 accordingly is meant to ease in explanation of the operations being performed and is not provided as a limiting implementation or configuration.

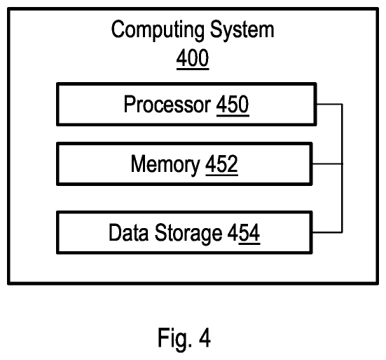

FIG. 4 illustrates a block diagram of an example computing system 400, according to at least one embodiment of the present disclosure. The computing system 400 may be configured to implement or direct one or more operations associated with a knowledge graph module, a GNN module, an input embedding module, a node identification module and/or a post-processing module (e.g., the knowledge graph module 204, the GNN module 208, the input embedding module 214, the node identification module 216 and/or the post-processing module 218 of FIG. 2). The computing system 400 may include a processor 450, a memory 452, and a data storage 454. The processor 450, the memory 452, and the data storage 454 may be communicatively coupled.

In general, the processor 450 may include any suitable special-purpose or general-purpose computer, computing entity, or processing device including various computer hardware or software modules and may be configured to execute instructions stored on any applicable computer-readable storage media. For example, the processor 450 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, the processor 450 may include any number of processors configured to, individually or collectively, perform or direct performance of any number of operations described in the present disclosure. Additionally, one or more of the processors may be present on one or more different electronic devices, such as different servers.

In some embodiments, the processor 450 may be configured to interpret and/or execute program instructions and/or process data stored in the memory 452, the data storage 454, or the memory 452 and the data storage 454. In some embodiments, the processor 450 may fetch program instructions from the data storage 454 and load the program instructions in the memory 452. After the program instructions are loaded into memory 452, the processor 450 may execute the program instructions.

For example, in some embodiments, one or more of the above-mentioned modules (e.g., the knowledge graph module 204, the GNN module 208, the input embedding module 214, the node identification module and/or the post-processing module 218 of FIG. 2) may be included in the data storage 454 as program instructions. The processor 450 may fetch the program instructions of a corresponding module from the data storage 454 and may load the program instructions of the corresponding module in the memory 452. After the program instructions of the corresponding module are loaded into memory 452, the processor 450 may execute the program instructions such that the computing system may implement the operations associated with the corresponding module as directed by the instructions.

The memory 452 and the data storage 454 may include computer-readable storage media for carrying or having computer-executable instructions or data structures stored thereon. Such computer-readable storage media may include any available media that may be accessed by a general-purpose or special-purpose computer, such as the processor 450. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 450 to perform a certain operation or group of operations.

Modifications, additions, or omissions may be made to the computing system 400 without departing from the scope of the present disclosure. For example, in some embodiments, the computing system 400 may include any number of other components that may not be explicitly illustrated or described.

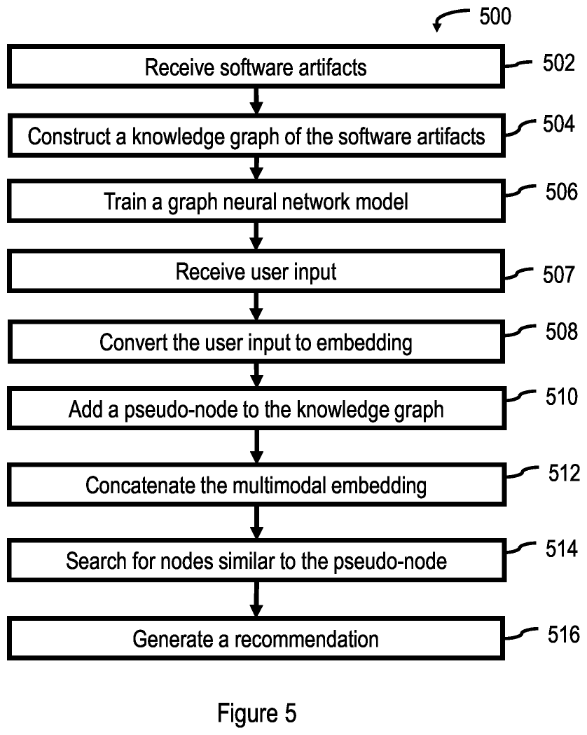

FIG. 5 is a flowchart of an example method 500. In some aspects, the method 500 may be implemented to train a graph neural network model to recommend one or more of the previously developed software entities for a software development objective. Additionally or alternatively, the method 500 may be implemented to recommend software or software entities for use in software development. The method 500 may be performed by any suitable system, apparatus, or device. For example, one or more of the knowledge graph module 204, the GNN module 208, the input embedding module 214, the node identification module and/or the post-processing module 218 of FIG. 2, or the computing system 400 of FIG. 4 (e.g., as directed by one or more modules) may perform one or more of the operations associated with the method 500. Although illustrated with discrete blocks, the steps and operations associated with one or more of the blocks of the method 500 may be divided into additional blocks, combined into fewer blocks, or eliminated, depending on the particular implementation.

The method 500 may begin at block 502, in which software artifacts may be received. In some aspects, the software artifacts may represent previously developed software entities from one or more repository sources. The software artifacts may include one or more of: an open source software package, a Dockerfile, a Docker image, a Docker base image, a repository, a Docker-compose file, and a helm chart.

At block 504, a knowledge graph of the software artifacts may be constructed. In some aspects, the knowledge graph may include nodes representing the software artifacts, and edges representing relationships between the software artifacts.

At block 506, a graph neural network model may be trained. In some aspects, the graph neural network model may be trained using the knowledge graph. The graph neural network model may be trained to recommend one or more of the previously developed software entities for a software development objective.

At block 507, a user input may be received. The user input may be input, for example, via a user interface. The user input may include a natural language query. At block 508, the user input may be converted to embedding based on the natural language query. In some aspects, the embedding of the user input may be combined with other modalities (e.g., embedding of packages and/or embedding of other software modules) to generate multimodal embedding. Thus, in some configurations the user input may be converted to multimodal embedding.

At block 510, a pseudo-node may be added to the knowledge graph. The pseudo-node may include the multimodal embedding.

At block 512, the multimodal embedding may be concatenated with edges in the knowledge graph to generate graph embedding for the pseudo-node. At block 514, the knowledge graph may be searched to identify one or more nodes similar to the pseudo-node in the knowledge graph.

At block 516, a recommendation may be generated. The recommendation may include one or more of the previously developed software entities to be used for the software development objective. The recommendation may be based on the nodes similar to the pseudo-node in the knowledge graph.

Modifications, additions, or omissions may be made to the method 500 without departing from the scope of the present disclosure. For example, the operations of method 500 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

As indicated above, the embodiments described in the present disclosure may include the use of a special purpose or general purpose computer (e.g., the processor 450 of FIG. 4) including various computer hardware or software modules, as discussed in greater detail below. Further, as indicated above, embodiments described in the present disclosure may be implemented using computer-readable media (e.g., the memory 452 or data storage 454 of FIG. 4) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the append d claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A method comprising:
receiving software artifacts representing previously developed software entities from one or more repository sources;
constructing a knowledge graph of the software artifacts, the knowledge graph representing characteristics of the software entities associated with the different software artifacts and representing relationships and interdependencies between the software entities associated with the different software artifacts; and
training, using the knowledge graph, a graph neural network model to recommend one or more of the previously developed software entities for a software development objective, the training being based on how the relationships and interdependencies relate to different functionalities of the developed software entities as related to different software development objectives and including aggregating embedding information of the knowledge graph such that pairs of entities that are deemed close in relation to each other, based on positional relationships to each other in the knowledge graph, are embedded together.

2. The method of claim 1, further comprising generating a recommendation including one or more of the previously developed software entities to be used for the software development objective.

3. The method of claim 1, further comprising:
receiving a user input, wherein the user input includes a natural language query;
converting the user input to multimodal embedding based on the natural language query; and
adding a pseudo-node to the knowledge graph including the multimodal embedding.

4. The method of claim 3, further comprising concatenating the multimodal embedding with edges in the knowledge graph to generate graph embedding for the pseudo-node.

5. The method of claim 4, further comprising:
searching for one or more nodes similar to the pseudo-node in the knowledge graph;
generating a recommendation including one or more of the previously developed software entities to be used for the software development objective, wherein the recommendation is based on the nodes similar to the pseudo-node in the knowledge graph.

6. The method of claim 1, wherein the software artifacts includes one or more of: an open source software package, a Dockerfile, a Docker image, a Docker base image, a repository, a Docker-compose file, and a helm chart.

7. The method of claim 1, wherein the knowledge graph comprises:
nodes representing the software artifacts; and
edges representing relationships between the software artifacts.

8. One or more non-transitory computer-readable storage media storing instructions that, in response to being executed by one or more processors cause a system to perform operations, the operations comprising:
receiving software artifacts representing previously developed software entities from one or more repository sources;
constructing a knowledge graph of the software artifacts, the knowledge graph representing characteristics of the software entities associated with the different software artifacts and representing relationships and interdependencies between the software entities associated with the different software artifacts; and
training, using the knowledge graph, a graph neural network model to recommend one or more of the previously developed software entities for a software development objective, the training being based on how the relationships and interdependencies relate to different functionalities of the developed software entities as related to different software development objectives and including aggregating embedding information of the knowledge graph such that pairs of entities that are deemed close in relation to each other, based on positional relationships to each other in the knowledge graph, are embedded together.

9. The one or more non-transitory computer-readable storage media of claim 8, the operations further comprising generating a recommendation including one or more of the previously developed software entities to be used for the software development objective.

10. The one or more non-transitory computer-readable storage media of claim 8, the operations further comprising:
receiving a user input, wherein the user input includes a natural language query;
converting the user input to multimodal embedding based on the natural language query; and
adding a pseudo-node to the knowledge graph including the multimodal embedding.

11. The one or more non-transitory computer-readable storage media of claim 10, the operations further comprising concatenating the multimodal embedding with edges in the knowledge graph to generate graph embedding for the pseudo-node.

12. The one or more non-transitory computer-readable storage media of claim 11, the operations further comprising:
searching for one or more nodes similar to the pseudo-node in the knowledge graph;
generating a recommendation including one or more of the previously developed software entities to be used for the software development objective, wherein the recommendation is based on the nodes similar to the pseudo-node in the knowledge graph.

13. The one or more non-transitory computer-readable storage media of claim 8, wherein the software artifacts includes one or more of: an open source software package, a Dockerfile, a Docker image, a Docker base image, a repository, a Docker-compose file, and a helm chart.

14. The one or more non-transitory computer-readable storage media of claim 8, wherein the knowledge graph comprises:
nodes representing the software artifacts; and
edges representing relationships between the software artifacts.

15. A software recommendation system comprising:
a user interface;
one or more processors; and
one or more computer-readable storage media storing instructions that, in response to being executed by the one or more processors cause the system to perform operations, the operations comprising:
receiving software artifacts representing previously developed software entities from one or more repository sources;
constructing a knowledge graph of the software artifacts, the knowledge graph representing characteristics of the software entities associated with the different software artifacts and representing relationships and interdependencies between the software entities associated with the different software artifacts;
training, using the knowledge graph, a graph neural network model, the training being based on how the relationships and interdependencies relate to different functionalities of the developed software entities as related to different software development objectives and including aggregating embedding information of the knowledge graph such that pairs of entities that are deemed close in relation to each other, based on positional relationships to each other in the knowledge graph, are embedded together; and
in response to a user input received at the user interface, generating a recommendation including one or more of the previously developed software entities to be used for a software development objective.

16. The software recommendation system of claim 15, wherein the user input includes a natural language query.

17. The software recommendation system of claim 15, the operations further comprising:
converting the user input to multimodal embedding based on a natural language query included in the user input;
adding a pseudo-node to the knowledge graph including the multimodal embedding; and
concatenating the multimodal embedding with edges in the knowledge graph to generate graph embedding for the pseudo-node.

18. The software recommendation system of claim 17, the operations further comprising:
searching for one or more nodes similar to the pseudo-node in the knowledge graph;
wherein generating the recommendation is based on the nodes similar to the pseudo-node in the knowledge graph.

19. The software recommendation system of claim 15, wherein the software artifacts includes one or more of: an open source software package, a Dockerfile, a Docker image, a Docker base image, a repository, a Docker-compose file, and a helm chart.

20. The software recommendation system of claim 15, the user interface configured to display the knowledge graph, and the knowledge graph comprising:
nodes representing the software artifacts; and
edges representing relationships between the software artifacts.
